(19) United States
(12) Patent Application Publication
(10) Pub. No.: US 2003/0226016 A1
(43) Pub. Date: Dec. 4, 2003

(54) Assurance of authentication in a computer system apparatus and method

(75) Inventors: David Carroll Challener, Raleigh, NC (US); James Patrick Hoff, Raleigh, NC (US); Howard Jeffrey Locker, Cary, NC (US); James Peter Ward, Raleigh, NC (US)

Correspondence Address: IBM CORPORATION, PO BOX 12195, DEPT 9CCA, BLDG 002, RESEARCH TRIANGLE PARK, NC, 27709, US

(73) Assignee: INTERNATIONAL BUSINESS MACHINES CORPORATION, Armonk, NY (US)

(21) Appl. No.: 10/063,988

(22) Filed: May 31, 2002

(51) Int. Cl. H04L 9/00

(52) U.S. Cl. 713/168; 713/186

(57) ABSTRACT

A computer system and method of operation in which a second input device which requires a second authenticating input in order to enable recognition of an authenticating input from a conventional keyboard is selectively interposed between the keyboard and a security element associated with the system motherboard.

### BACKGROUND OF INVENTION

Concern over the security and authenticity of transactions through and over computer systems has become a growing concern as the use of computer systems has proliferated. That concern has given rise to the Trusted Computing Platform Alliance, also know as the TCPA. The Design Philosophies statement of the TCPA states that the purpose of the activity is to encourage the use of computer platforms for critical purposes by improving the basis on which a computing environment may be trusted.

The TCPA has developed a specification in addition to the Design Philosophy statement, and included in their materials a glossary of terminology used in their discussions. Certain terms appearing hereinafter may be found in that glossary as well as having meaning apart from the glossary definitions offered by the TCPA. While it is intended that the glossary definitions will be helpful, it is to be recognized at the outset of the discussion which follows that those definitions are deemed illustrative only and not fully binding on the terminology used. The choice of TCPA defined terms is made only for convenience and as an aid to understanding, avoiding restriction to those definitions as the meaning of the terminology is expected to expand as the technology becomes into wider use.

A Trusted Platform is a platform that can be trusted by local users and by remote entities. TCPA uses a behavioral definition of trust: an entity can be trusted if it always behaves in the expected manner for the intended purpose. The basis for trusting a platform, or computer system, is a declaration by a known authority that a platform with a given identity can be trusted to measure and report the way it is operating.

One possibility for a trusted platform is the authentication by a user of a file or document generated at the platform or system and passed, supplied or delivered to another platform or system. Such transfer of a file or document may be by any of the known channels or forms of communicating data. When a user desires to give assurance that the data being transferred has been originated by that user, a process of authentication is initiated. That is, some “signature” or authenticating data is supplied which gives the appropriate assurance to a recipient as to the “trustability” of the origin of the data.

As will be understood, it is of importance that such signature be maintained as trustworthy. For that purpose, various forms of attack on the trusted capabilities for such a signature should be anticipated. The present invention deals with one such form of attack.

It is somewhat conventional for protection of authentication capabilities to be achieved by use of passwords or passphrases. Computer system users are likely familiar with such capabilities as power-on, hard drive and network passwords, as well as passwords for access to secured internet sites. An authenticating signature capability is similarly protected. Such passwords or passphrases are typically entered from the conventional alphanumeric keyboard coupled to a computer system.

However, attacks may become focused on necessary transition points in the use of computer systems. For example, a user may wish to create a file or document while the system is in a insecure state, and then later provide that file or document in a trusted form. In order to arrive at the trusted form, the user must reach and apply the TCPA functions which establish the trustworthiness of the system, and then supply the signature. The transition from the insecure to the trusted states may present a conceivable avenue of attack for a person wishing to subvert the trusted nature of the system. For example, a keystroke capture program of a type operating outside the awareness of the user may capture and report keystrokes entered at a system keyboard, as is conventionally done with passwords or passphrases. Such operation may expose the system to capture of passwords or passphrases for nefarious purposes.

### SUMMARY OF INVENTION

In order to avoid the likelihood of inadvertent disclosure or attachment of an authenticating data string, what is described hereinafter is a computer system, and method of operation which selectively interposes between a conventional computer system keyboard and a security element associated with the system motherboard a second input device which requires a second authenticating input in order to enable recognition of an authenticating input from the conventional keyboard.

### BRIEF DESCRIPTION OF DRAWINGS

Some of the purposes of the invention having been stated, others will appear as the description proceeds, when taken in connection with the accompanying drawings, in which:

FIG. 1 is an illustration of a computer system in which the present invention is implemented;

FIG. 2 is an illustration drawn from the TCPA PC Specific Implementation Specification to illustrate the presence of certain elements of the system of FIG. 1;

FIG. 3 is a schematic representation of one manner of interposing a second input device between a first input device and a security element; and

FIG. 4 is a schematic representation of another manner of controlling the interposing of a second input device between a first input device and a security element.

### DETAILED DESCRIPTION

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of the invention. Accordingly, the description which follows is to be understood as being a broad, teaching disclosure directed to persons of skill in the appropriate arts, and not as limiting upon the present invention.

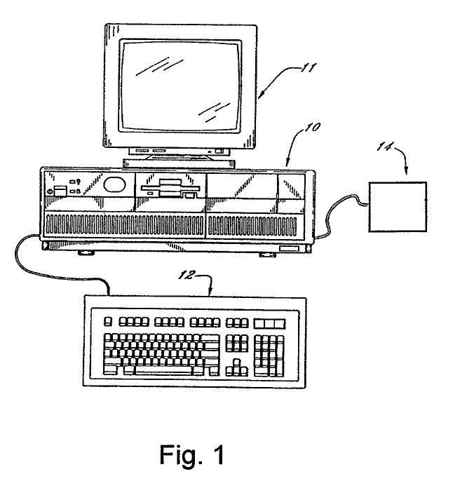

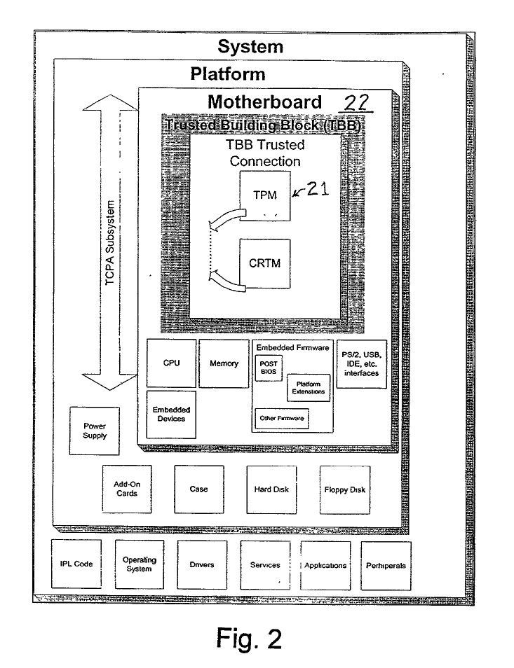

Referring now to FIG. 1, a computer system is there shown and generally identified at 10. The system includes a display 11 and a keyboard 12 associated with the system 10. In accordance with this invention, the system is provided with a Trusted Platform Module (TPM) indicated at 21 in FIG. 2. The keyboard 12 serves as a primary data entry device, including data directed at the TPM 21 such as a password or passphrase necessary to exercise trusted computing functions such as authentication of a signature.

The TPM 21 may be implemented by the provision of a special purpose semiconductor package coupled to the motherboard indicated at 22 in FIG. 2. The semiconductor package, also sometimes referred to as a chip or application specific integrated circuit (ASIC), may be coupled to the motherboard 22 in at least two ways: by mounting on a daughter card which is received in a socket provided on the motherboard, or by soldering directly onto the motherboard as the motherboard is manufactured. A daughter card, as is known to persons of skill in the appropriate arts, is a small printed circuit board mounting one or a few components and received in a socket provided on the motherboard. An example is shown in FIG. 5 of U.S. Pat. No. 5,301,343 issued Apr. 5, 1994, where a daughter card 190 is received in a socket 195 provided on a motherboard 120. To any extent necessary to an understanding of this invention, this disclosure is incorporated by this reference. In the present illustrative embodiment, the component mounted on the daughter card will be the TPM, rather than the memory elements disclosed in the referenced patent.

In either arrangement, or in any other arrangement which the person of skill in the applicable arts may devise within the scope of this invention, provision is made for selectively interposing a second input device between the keyboard 12 and the TPM 21. Two points are of interest in this regard: the manner in which the device is selectively interposed and the nature of the second input device. The second input device is indicated at 14 in FIG. 1.

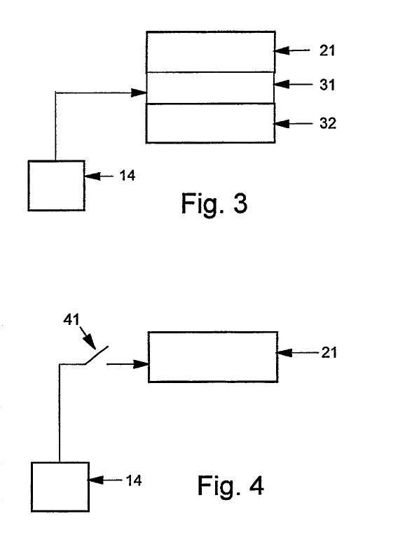

Turning first to the manner in which the device is selectively interposed, one manner of such interposition is physical. That is, the device 14 may be connected between the motherboard connector and the daughter card bearing the TPM 21, as by providing an interposer connector 31 having the requisite male and female coupling surfaces and appropriate signal passing pathways to place the second device in the path of communication from the keyboard 12 to the TPM 21 through a motherboard connector 32. See FIG. 3. Alternatively, and in instances where an connector is unavailable for such interposition, the second device may be connected through a switch 41 settable to two states, one in which the second device 14 is interposed and the other in which direct data transfer from the keyboard to the TPM 21 is enabled. See FIG. 4.

The second device 14 may be a numeric keypad or a biometric measuring device such as a fingerprint or retinal scanner or a key acceptor such as a card reader capable of accepting and reading magnetic stripe or code bearing smart cards. The numeric keypad is perhaps the simplest form, and is useful where the secondary security requirement imposed is entry of a digital string of numbers, such as those known as a Personal Identification Number (PIN). A biometric measurement device is useful where the secondary security requirement is to be tied to a specific individual. A key acceptor is useful where the secondary security requirement is to be tied to the possession of a physical key such as the mentioned cards.

With the second input device interposed, entry of a password through the conventional keyboard 12 will be insufficient to access the secure functions achievable through the TPM 21. Instead, the keystrokes necessarily entered through the first input device 12 must be validated by compliance with the secondary security requirement in order for the entry to become effective. Thus capture of those keystrokes alone will fail to make the secure levels of the trusted computing platform accessible and a greater assurance of authentication is achieved.

It is contemplated, as will be clear from the discussion above, that this higher level of assurance can be selected or deselected. Where such selection is done by either inserting or removing the interposer connector of FIG. 3, an authorized person such as a system administrator may effectuate a decision as to the level of assurance desired. With switch selection, moving between the levels of assurance may be more easily effectuated, should that be desired. The switch 41 may be positioned accessible to a user or within the computer housing so as to normally be inaccessible to the user.

In operation, the computer system 10 operates in accordance with a method in which the keyboard 12 is coupled to a security element 21 in a trusted computing platform system to enable entry of data to the security element, and a second input device imposing a security requirement for effective entry of data to the security element from the keyboard is selectively interposed between the keyboard and the security element. The selective interposing may be accomplished, as described above, by physical interposition or by switching. The second device security requirement may be met by a PIN, a biometric measurement, or provision of a physical key.

In the drawings and specifications there has been set forth a preferred embodiment of the invention and, although specific terms are used, the description thus given uses terminology in a generic and descriptive sense only and not for purposes of limitation.

1. Apparatus comprising:
a computer system motherboard;
a security element coupled to said motherboard and enabling operation as a trusted computer platform;
a first input device coupled to said motherboard and enabling input of data to said security element; and
a second input device selectively interposed between said first input device and said security element and enabling selective imposition of a security requirement for effective input of data to said security element from said first input device.

2. Apparatus according to claim 1 wherein said security element is mounted on said motherboard.

3. Apparatus according to claim 2 further comprising a daughter card and wherein said motherboard has a security element socket receiving said daughter card and said security element mounted on said daughter card.

4. Apparatus according to claim 1 wherein said first input device is a keyboard.

5. Apparatus according to claim 1 wherein said second input device is a keypad.

6. Apparatus according to claim 1 wherein said second input device is a biometric measuring device.

7. Apparatus according to claim 1 wherein said second input device is a card reader.

8. Apparatus according to claim 1 further comprising a switch interposed between said second input device and said security element and selectively enabling interposition of second input device.

9. Apparatus comprising:
a computer system motherboard;
a security element mounted on said motherboard and enabling operation as a trusted computer platform;
a first input device coupled to said motherboard and enabling input of data to said security element;
a second input device coupled to said first input device and said security element and enabling imposition of a security requirement for effective input of data to said security element from said first input device; and
a switch interposed between (a) said second input device and (b) said first input device and said security element and enabling selective interposition of said second input device between said first input device and said security element.

10. A method comprising the steps of:
coupling a keyboard to a security element in a trusted computing platform system to enable entry of data to the security element; and
selectively interposing between the keyboard and the security element a second input device imposing a security requirement for effective entry of data to the security element from the keyboard.

11. A method according to claim 10 wherein the step of selectively interposing a second input device comprises switching the state of connection of a second input device between being interposed and being excluded from interposition.

12. A method according to claim 10 wherein the step of selectively interposing a second input device and imposing a security requirement comprises imposing a requirement for entry of a numeric sequence.

13. A method according to claim 10 wherein the step of selectively interposing a second input device and imposing a security requirement comprises imposing a requirement for entry of a biometric measurement.

14. A method according to claim 10 wherein the step of selectively interposing a second input device and imposing a security requirement comprises imposing a requirement for submission of a physical key.
